(19) United States
(12) Patent Application Publication
(10) Pub. No.: US 2025/0128987 A1
(43) Pub. Date: Apr. 24, 2025

(54) VISCOSITY REDUCER FOR ASPHALT RECYCLED MATERIAL, METHOD OF PREPARING VISCOSITY REDUCER FOR ASPHALT RECYCLED MATERIAL AND METHOD FOR APPLYING THE SAME TO RECYCLED ASPHALT CONCRETE MATERIAL

(71) Applicant: TAIWAN GWAN CHIAN INDUSTRIAL CO., LTD., Taoyuan City (TW)

(72) Inventors: Ting-Chen CHEN, Taoyuan City (TW); Yuan-Tsung HSU, Taoyuan City (TW)

(21) Appl. No.: 18/751,364

(22) Filed: Jun. 24, 2024

(30) Foreign Application Priority Data
Oct. 20, 2023 (TW) 112140303

(51) Int. Cl. C04B 7/24; C04B 26/26; C04B 40/00; C04B 103/30; C04B 103/40; C04B 111/00

(52) U.S. Cl. CPC C04B 7/24; C04B 26/26; C04B 40/0032; C04B 2103/34; C04B 2103/408; C04B 2111/0075; C04B 2201/10

(57) ABSTRACT

A viscosity reducer for asphalt recycled material is provided by this disclosure. The viscosity reducer for asphalt recycled material includes 10% to 40% by weight of a surface active dispersant, 20% to 40% by weight of a penetrant, 1% to 5% by weight of a plasticizer, 0% to 5% by weight of a emulsifier and the remaining proportion is a diluent. In addition, a method of preparing a viscosity reducer for asphalt recycled material is also disclosed in this disclosure. Besides, a method for applying a viscosity reducer for asphalt recycled material to recycled asphalt concrete material is also disclosed in this disclosure.

### CROSS-REFERENCE TO RELATED APPLICATION

This application claims priority to Taiwan Application Serial Number 112140303 filed Oct. 20, 2023, the disclosures of which are incorporated herein by reference in their entireties.

### BACKGROUND

### Field of Invention

This disclosure is related to a viscosity reducer, in particular to, related to a viscosity reducer for asphalt recycled material, a method of preparing viscosity reducer for asphalt recycled material and a method for applying the same to recycled asphalt concrete material.

### Description of Related Art

According to statistics from the Ministry of Transportation and Communications, more than 90% of roads in Taiwan use asphalt concrete pavements. These asphalt concrete pavements are damaged due to factors of vehicle rolling, aging of the asphalt and so on, so the asphalt concrete pavements are repaired and renovated at regular intervals, resulting in a large amount of reclaimed asphalt pavement (RAP). If the RAP is directly thrown away, it may not only cause environmental pollution, but also cause huge waste of resources. A better way to solve the problems is to recycle the RAP and add new sand, stone and asphalt to make recycled asphalt concrete. In this way, the method may not only effectively solve the problem of environmental pollution caused by waste accumulation, but also have good resource utilization and economic benefits.

In view of this, to widely use recycled asphalt concrete, it is first necessary to solve the aging problem of asphalt in the road environment.

### SUMMARY

Embodiments of this disclosure provide a viscosity reducer for asphalt recycled material. The viscosity reducer for asphalt recycled material includes 10% to 40% by weight of a surface active dispersant, 20% to 40% by weight of a penetrant, 1% to 5% by weight of a plasticizer, 0% to 5% by weight of a emulsifier, and a remaining proportion of a diluent.

Embodiments of this disclosure provide a method of preparing a viscosity reducer for asphalt recycled material, including the following steps. 10 wt % to 40 wt % of a surface active dispersant, 20 wt % to 40 wt % of a penetrant, 1 wt % to 5 wt % of a plasticizer, 0 wt % to 5 wt % of a an emulsifier, and a remaining proportion of a diluent are weighed, respectively. The surface active dispersant and the penetrant are put into a stirring tank. A temperature of the stirring tank is heated up to from 40° C. to 70° C., and the stirring tank is stirred at a rotation speed of 300 rpm to 500 rpm for 10 minutes to 15 minutes. The temperature is maintained, and the diluent is added and stirred at the rotation speed for 10 minutes to 15 minutes. The plasticizer and/or emulsifier are/is added and stirred at the rotation speed for 15 minutes to 30 minutes to form a mixture, then the mixture is cooled to a room temperature.

Embodiments of this disclosure provide method for applying a viscosity reducer for asphalt recycled material to a recycled asphalt concrete material, including the following steps. The recycled asphalt concrete material is provided, wherein the recycled asphalt concrete material includes an aged asphalt. A new asphalt is added. The recycled asphalt concrete material and the new asphalt are mixed evenly at a temperature of from 145° C. to 180° C., and the viscosity reducer for asphalt recycled material is added and mixed continuously and evenly at the temperature to obtain an asphalt concrete regenerated material. The viscosity reducer for asphalt recycled material includes a surface active dispersant, and the surface active dispersant includes a plurality of hydrophilic ends and a plurality of lipophilic ends. After the plurality of lipophilic ends are adsorbed on a surface of the aged asphalt, the agglomerated aged asphalt is dispersed through a charge repulsion of a same charge among each of the plurality of hydrophilic ends, so as to reduce an asphalt viscosity of the recycled asphalt concrete material.

Embodiments of this disclosure provide method for applying a viscosity reducer for asphalt recycled material to a recycled asphalt concrete material, including the following steps. The recycled asphalt concrete material and a new concrete material are mixed at a temperature of from 145° C. to 180° C. evenly to form a first recycled material mixture, wherein the recycled asphalt concrete includes an aged asphalt. A new asphalt are added into the first recycled material mixture, and the first recycled material mixture and the new asphalt are mixed at the temperature to form a second recycled material mixture. The viscosity reducer for asphalt recycled material is added into the second recycled material mixture, and the second recycled material mixture is mixed continuously and evenly at the temperature to obtain an asphalt concrete regenerated material. The viscosity reducer for asphalt recycled material includes a surface active dispersant, and the surface active dispersant includes a plurality of hydrophilic ends and a plurality of lipophilic ends. After the plurality of lipophilic ends are adsorbed on a surface of the aged asphalt, the agglomerated aged asphalt is dispersed through a charge repulsion of a same charge among each of the plurality of hydrophilic ends, so as to reduce an asphalt viscosity of the recycled asphalt concrete material.

### BRIEF DESCRIPTION OF THE DRAWINGS

In order to make the purpose, features, advantages and embodiments of this disclosure more clearly understandable, the detailed description of the attached figures is as follows:

FIG. 1 a schematic diagram of a cause and a mechanism of asphalt aging;

FIG. 2 is a flow chart of a method for preparing a viscosity reducer for asphalt recycled material according to some embodiments of this disclosure;

FIG. 3 is a flow chart of a method for applying a viscosity reducer of asphalt recycled material to a recycled asphalt concrete material according to some embodiments of this disclosure; and

FIG. 4 is a schematic diagram of a principle process of dispersing an aged asphalt in a recycled asphalt material through a viscosity reducer for asphalt recycled material according to some embodiments of this disclosure.

### DETAILED DESCRIPTION

The spirit of this disclosure will be clearly explained in the following figures and detailed descriptions. A person having ordinary skill in the art can make changes and modifications based on the technology disclosed in this disclosure after understanding the preferred embodiments of this disclosure without departing from the spirit and scope of this disclosure.

The words “comprise”, “include”, “have”, “contain” and the like used in the present disclosure are open terms, meaning including but not limited to.

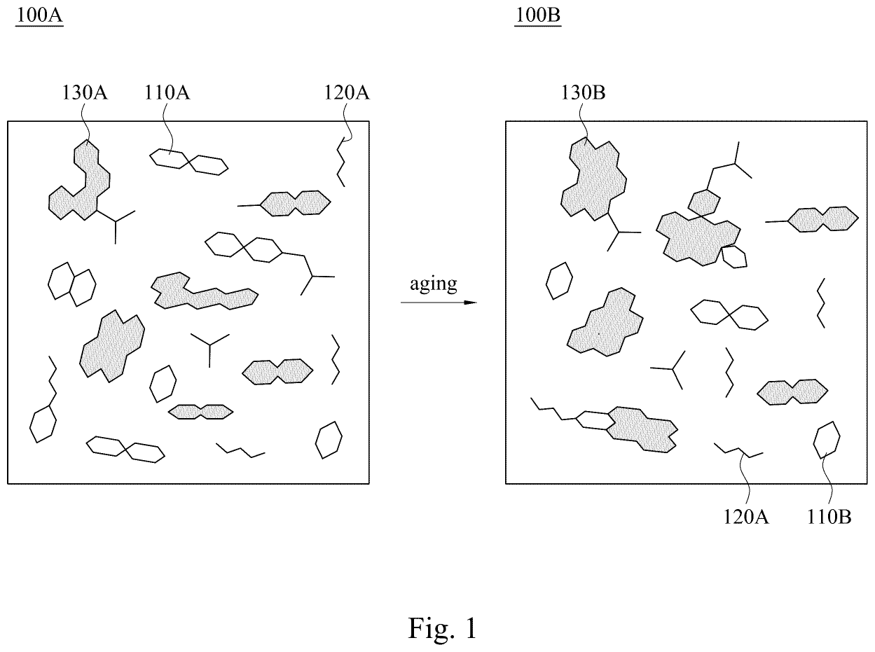

Please refer to FIG. 1. FIG. 1 a schematic diagram of a cause and a mechanism of asphalt aging. As shown in an asphalt 100A in FIG. 1, components of the asphalt 100A mainly include aromatic hydrocarbons 110A (including aromatic hydrocarbons and polar aromatic hydrocarbons), saturated hydrocarbons 120A, and asphaltenes 130A. The asphalt aging refers to a process that the oxidation, volatilization, polymerization and/or agglomeration of asphalt due to long-term exposure to the air, under actions of oxygen, high heat, sunlight and water, causing a structure of the asphalt 100A to change, so as to cause deterioration of a performance of an asphalt concrete pavement.

As shown in an aged asphalt 100B in FIG. 1, during the aging process of asphalt, a ratio of an aromatic hydrocarbon 110B in the original asphalt 100A is decreased, while a ratio of an asphaltenes 130A is increased. That is, the asphalt 100A becomes the agglomerated aged asphalt 130B. At this time, a softening point and a viscosity of the aged asphalt 100B is also increased, causing the aged asphalt 100B to become hard, brittle, lose elasticity and reduce adhesiveness. Thus, the aged asphalt 100B seriously affects the performance of the asphalt concrete pavement and reduces the durability of the asphalt concrete pavement, shortening the service life of the asphalt concrete pavement.

Accordingly, to overcome the problem of asphalt aging, embodiments of this disclosure provides a viscosity reducer for asphalt recycled material. The viscosity reducer for asphalt recycled material includes 10% to 40% by weight of a surface active dispersant, 20% to 40% by weight of a penetrant, 1% to 5% by weight of a plasticizer, 0% to 5% by weight of a emulsifier, and a remaining proportion of a diluent. The diluent is 10% to 69% by weight.

In some embodiments, the surface active dispersant is lignin sulfonate, humic acid sulfonate, polyoxyindene resin sulfonate, aryl sulfonate-formaldehyde condensate, aliphatic hydroxysulfonate-formaldehyde condensate, phenyl polyoxyethylene ether-formaldehyde condensate, polycarboxylic acid compound or a combination thereof. In some embodiments, preferably, the aryl sulfonate-formaldehyde condensate includes naphthalene sulfonate-formaldehyde condensate, onion sulfonate-formaldehyde condensate, aminoaryl sulfonate-phenol-formaldehyde condensate, Melamine sulfonate-formaldehyde condensate or combinations thereof. In some embodiments, preferably, the polycarboxylic acid compound includes polyacrylate, methacrylic acid-methoxypolyoxyethylene acrylate copolymer, maleic anhydride-allyl polyoxyethylene ether copolymer, acrylic acid-ethylene glycol monovinyl polyoxyethylene ether copolymer, acrylic acid-methallyl polyoxyethylene ether copolymer, acrylic acid-isopentenyl polyoxyethylene ether copolymer, acrylic acid-4-hydroxybutyl vinyl polyoxyethylene ether copolymer, styrene-acrylic acid copolymer, styrene-maleate copolymer, styrene-acrylic acid-itaconic acid copolymer, styrene-acrylic acid-methoxypolyoxyethylene acrylate copolymer, styrene-maleic acid-methoxy polyoxyethylene acrylate copolymer, styrene-acrylic acid-methoxy polyoxyethylene polyoxypropylene acrylate copolymer, styrene-maleic acid-methoxy polyoxyethylene acrylate copolymer oxypropylene acrylate copolymer, polyamide-polyamide imine copolymer or a combination thereof.

It is worth to mention that the surface active dispersant includes a plurality of lipophilic ends and a plurality of hydrophilic ends. The hydrophilic ends of the surface active dispersant are positively or negatively charged. Through the lipophilic ends of the surface active dispersant, the lipophilic ends of the surface active dispersant are absorbed on a surface of the aged asphalt (such as the aged asphalt 130B in FIG. 1). Then, through a repulsive mechanism of the same charge (i.e. positive or negative charge) on the hydrophilic ends, the agglomerated aged asphalt is dispersed. The detail mechanism is explained later.

In some embodiments, the penetrant comprises alkyl polyoxyethylene ether, alkylphenol polyoxyethylene ether, aromatic hydrocarbon polyoxyethylene ether, styrene aromatic hydrocarbon polyoxyethylene ether, polyol polyoxyethylene ether, alkylamine polyoxyethylene ether, alkyl polyoxyethylene polyoxypropylene ether, alkylphenol polyoxyethylene polyoxypropylene ether, aromatic hydrocarbon polyoxyethylene polyoxypropylene ether, styrene aromatic hydrocarbon polyoxyethylene, polyoxypropylene ether, polyol polyoxyethylene polyoxypropylene ether, alkylamine polyoxyethylene polyoxypropylene ether, alkyl phosphate, alkyl polyoxyethylene ether alcohol phosphate, alkylphenol polyoxyethylene ether alcohol phosphate, ethoxylated fatty alcohol, fatty alcohol polyoxyethylene ether, fatty alcohol polyetheramide, polyurethane, polyurethane-acrylic copolymer, or a combination thereof. In addition, the penetrant allows the surface active dispersant to penetrate into the agglomerated aged asphalt.

In some embodiments, the plasticizer is sodium carboxymethyl starch, carboxymethyl cellulose, hydroxyethyl cellulose, hydroxypropyl cellulose, triethyl citrate, acetyltriethyl acetate, tributyl citrate, acetyltributyl acetate, acetyltrihexyl acetate, acetylated monoglyceride, dibutyl maleate, tributyl phosphate, phthalates, terephthalates, or a combination thereof.

In some embodiments, the emulsifier is a carboxylate emulsifier, a sulfonate emulsifier, an ammonium salt emulsifier, an alkylphenol polyoxyethylene ether emulsifier, benzylphenol polyoxyethylene ether, phenethylphenol polyoxyethylene ether, fatty alcohol polyoxyethylene ether, or a combination thereof. The function of the emulsifier is to combine water molecules with oily molecules, so that the water molecules and the oily molecules may be mixed evenly. Therefore, the emulsifier is used when a water-solubility of the surface active dispersant, the penetrant and/or the plasticizer is poor.

In some embodiments, the diluent is water. The diluent may be configured to serve as a solvent for the surface active dispersant, the penetrant and/or the plasticizer to make the surface active dispersant, the penetrant and/or the plasticizer be mixed more evenly. Moreover, the diluent may make the surface active dispersant, the penetrant and/or the plasticizer have a lower viscosity, making the viscosity reducer for asphalt recycled material easier to be added into the recycled asphalt concrete material.

In related art, to overcome the problem of asphalt aging, petrochemical products, such as light oil or heavy oil with low-viscosity, are usually added a regenerant to reduce a viscosity of asphalt until reaching a range met a regulatory standard. However, although the regenerant made by adding the light oil or heavy oil can reduce the viscosity, the regenerant made by adding the light oil or heavy oil is relatively expensive. Moreover, the regenerant needs to be heated before using, and the regenerant is easy to cause combustion due to volatilization in a high-temperature production process. In addition, the use of the petroleum-based regenerant may substantially increase an asphalt content of asphalt concrete, resulting in the asphalt concrete pavement becoming softer due to the excessive asphalt content and prone to problems such as rutting and deformation.

As a result, the viscosity reducer for asphalt recycled material of embodiments of this disclosure reduces the viscosity of the asphalt by dispersing the aged asphalt (such as the aged asphalt 130B in FIG. 1) that has been agglomerated due to oxidation and high temperature. Moreover, the viscosity reducer for asphalt recycled material of embodiments of this disclosure may not increase the asphalt content of the recycled asphalt concrete material, and may not cause problems such as rutting and deformation of the asphalt concrete road surface.

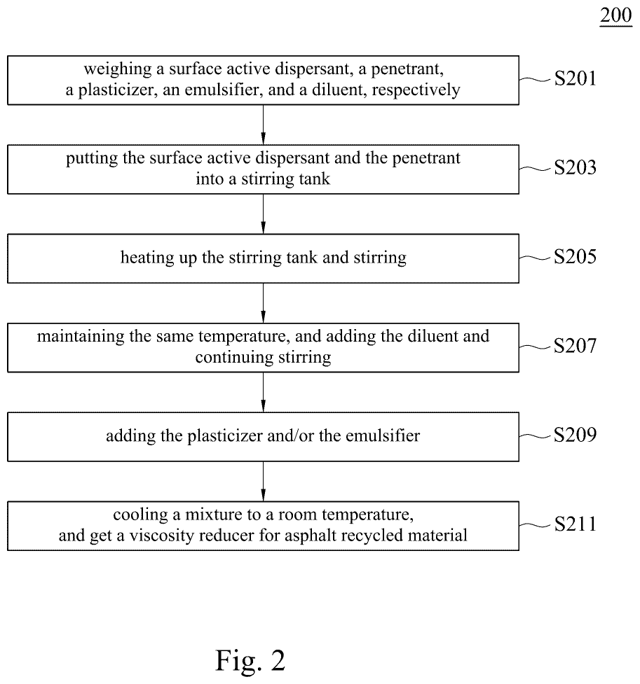

Further, in order to explain in more detail a mechanism of the viscosity reducer for asphalt recycled material of embodiments of this disclosure for processing the recycled asphalt concrete material containing the aged asphalt, please refer to FIG. 2. FIG. 2 is a flow chart of a method for preparing a viscosity reducer for asphalt recycled material according to some embodiments of this disclosure, that is, a preparing process 200.

In step S201, 10 wt % to 40 wt % of a surface active dispersant, 20 wt % to 40 wt % of a penetrant, 1 wt % to 5 wt % of a plasticizer, 0 wt % to 5 wt % of an emulsifier, and a remaining proportion of a diluent are weighed, respectively, as raw materials for a viscosity reducer for asphalt recycled material.

Next, in step S203, the surface active dispersant and the penetrant are put into a stirring tank. In step S205, a temperature of the stirring tank is heated up to from 40° C. to 70° C., and the surface active dispersant and the penetrant are stirred at a rotation speed of from 300 rpm to 500 rpm for 10 minutes to 15 minutes to mix evenly.

Further, in step S207, the temperature is maintained at the same temperature, and the diluent is added and stirred at the rotation speed of 300 rpm to 500 rpm for 10 minutes to 15 minutes to mix evenly.

Then, in step S209, the plasticizer and/or the emulsifier are/is added and stirred at the rotation speed of 300 rpm to 500 rpm for 10 minutes to 15 minutes to mix evenly. In step S211, the finished product of viscosity reducer for asphalt recycled material is obtained after cooling to room temperature.

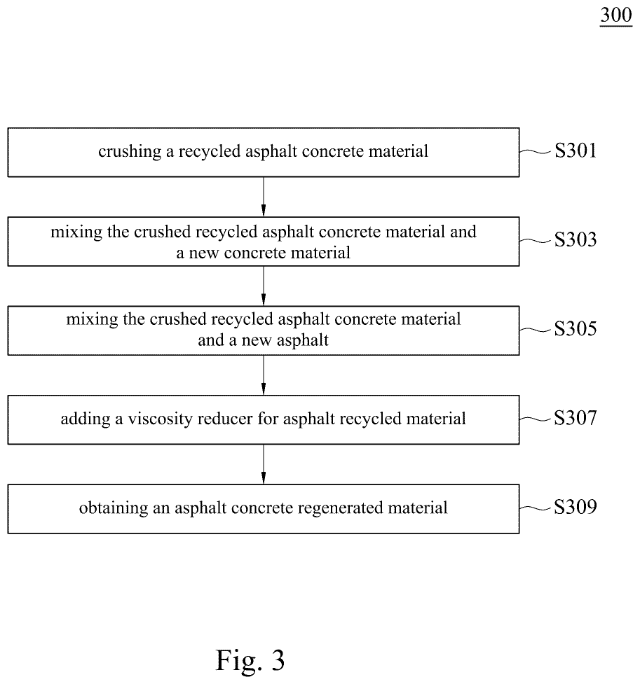

Furthermore, embodiments of this disclosure provide a method for applying a viscosity reducer for asphalt recycled material to a recycled asphalt concrete material. Please refer to FIG. 3. FIG. 3 is a flow chart of a method for applying a viscosity reducer of asphalt recycled material to a recycled asphalt concrete material according to some embodiments of this disclosure, that is, a process flow 300.

Firstly, in step S301, a recycled asphalt concrete material is crushed. Next, in step S303, the crushed recycled asphalt concrete material and a new concrete material are mixed. It is worth to mention that in some embodiments, the step S303 may be omitted. In other words, in some embodiments, the new concrete material may not be added.

Further, in step S305, the crushed recycled asphalt concrete material is mixed with new asphalt and mixed at from 145° C. to 180° C. to form a recycled material mixture. In the embodiments of performing the step S303, the recycled material mixture further includes the new concrete material. Moreover, the recycled asphalt concrete material includes aged asphalt. In addition, the aged asphalt refers to the agglomerated asphalt formed due to changes in the structure of the asphalt due to oxidation and high temperature, such as the aged asphalt 100B in FIG. 1.

Next, in step S307, a viscosity reducer for asphalt recycled material is added and mixed at from 145° C. to 180° C. Then, in step S309, an asphalt concrete regenerated material is obtained.

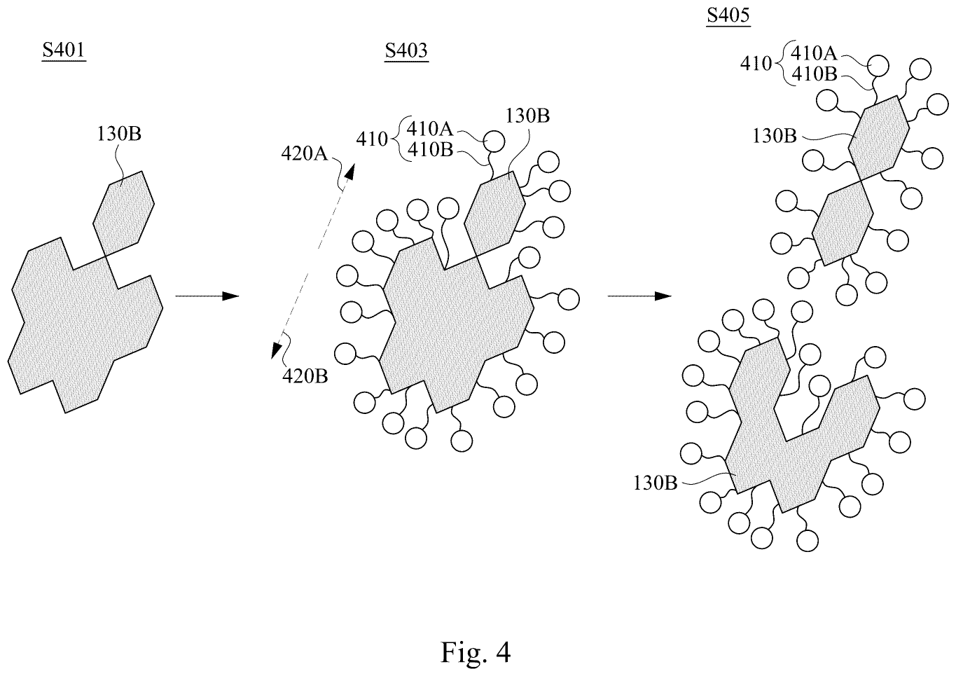

Further, please refer to FIG. 4. FIG. 4 is a schematic diagram of a principle process of dispersing aged asphalt in a recycled asphalt material through a viscosity reducer for asphalt recycled material according to some embodiments of this disclosure.

Process S401 illustrates a schematic diagram of the agglomerated aged asphalt 130B. Next, in process S403, a viscosity reducer for asphalt recycled material is added. Moreover, the lipophilic ends 410B of the surface active dispersant 410 in the viscosity reducer for asphalt recycled material are absorbed on the surface of the aged asphalt 130B. Additionally, it is worth to mention that the penetrant in the viscosity reducer for asphalt recycled material (not shown in FIG. 4) makes the surface active dispersant 410 easier penetrate into the aged asphalt 130B to enhance an absorption effect of the lipophilic ends 410B on the surface of the aged asphalt 130B.

The agglomerated aged asphalt is separated through charge repulsive forces among the hydrophilic ends 410A of the surface active dispersant 410 after the lipophilic ends 410B of the surface active dispersant 410 are absorbed on the surface of the non-polar aged asphalt 130B. For example, in process S403, charge repulsive forces 420A and 420B are represented by dashed arrows, and the charge repulsive forces 420A and 420B pull the aged asphalt 130B apart in opposite directions to each other. Next, as shown in process S405, the aggregated aged asphalt 130B is dispersed through the charge repulsive forces, such as the charge repulsive forces 420A and 420B.

Based on a characteristic of the lipophilic ends 410B and the hydrophilic ends 410A of the surface active dispersant 410 of the viscosity reducer for asphalt recycled material and a mechanism of dispersing the aged asphalt 130B due to the characteristic of the surface active dispersant 410, the viscosity of the aged asphalt may be reduced. Moreover, an overall asphalt content may not be increased, so that the high-quality asphalt concrete regenerated material met specifications may be produced.

Further, various results and characteristics of using the viscosity reducer for asphalt recycled material to treat a recycled asphalt concrete material according to this disclosure are described with various examples and various comparative examples.

Firstly, processing processes and characteristics of Comparative Examples 1 to 6 and Examples 1 to 6 are described in the following sections. Comparative Examples 1 to 6 are respectively corresponding to Examples 1 to 6, as shown in Tables 2 to 7.

Comparative Examples 1 to 6 are related to the processing processes and the characteristics of the recycled asphalt concrete material. The processing processes of the recycled asphalt concrete material of Comparative Examples 1 to 6 are as follow. A solvent, toluene, was used to extract asphalt from 1000 kilograms (kg) of the recycled asphalt concrete material. The recycled asphalt concrete material of Comparative Examples 1 to 6 contained different weights of aged asphalt (in kilograms, as shown in Tables 2 to 7). Additionally, a test for viscosity of the asphalt was performed through a method of test for viscosity (based on CNS 14186).

Examples 1 to 6 are related to a preparation formula of a viscosity reducer for asphalt recycled material, and the processing processes and the characteristics of the recycled asphalt concrete material.

Furthermore, the processing processes of the recycled asphalt concrete material of Examples 1 to 6 are as follows. The recycled asphalt concrete material was taken with a total weight of 1000 kg. The recycled asphalt concrete materials of Examples 1 to 6 respectively contained different weights of aged asphalt (in kilograms). In addition, the weight of the aged asphalt of the Example was the same as the weight of the aged asphalt of the corresponding Comparative Example. For example, the weight of the aged asphalt contained in the recycled asphalt concrete material of Comparative Example 1 was 42.2 kg, and the weight of the aged asphalt contained in the recycled asphalt concrete material of Example 1 was also 42.2 kg.

Then, a total weight of 2 kg of each of different formulations of the viscosity reducer for asphalt recycled material of Examples 1 to 6 was added respectively. That is, a weight ratio of the recycled asphalt concrete material and the viscosity reducer for asphalt recycled material was 500:1. The formulations of the viscosity reducer for asphalt recycled material of Example 1 to 6 are shown in Table 1. Next, the recycled asphalt concrete material and the viscosity reducer for asphalt recycled material are mixed at from 145° C. to 180° C. to form an asphalt concrete regenerated material. Further, the solvent, toluene, was used to extract asphalt from the recycled asphalt concrete material, and a test for viscosity of the asphalt was performed through the method of test for viscosity (based on CNS 14186).

Next, please refer to Table 1. Table 1 is a summary table of the formulations of the viscosity reducer for asphalt recycled material of Examples 1 to 6, wherein the total weight of the viscosity reducer for asphalt recycled material is calculated as 100 wt %.

TABLE 1

| | Compositions (wt %) | | | | |
|---|---|---|---|---|---|
| | Surface | | | | |
| | active | | | | |
| Examples | dispersant | Penetrant | Plasticizer | Emulsifier | Diluent |
| Example 1 | 30 | 20 | 1 | 0 | 49 |
| Example 2 | 20 | 33 | 1 | 0 | 46 |
| Example 3 | 35 | 20 | 1 | 1 | 43 |
| Example 4 | 30 | 25 | 1 | 0 | 44 |
| Example 5 | 12 | 40 | 1 | 0 | 47 |
| Example 6 | 36 | 20 | 1 | 0 | 43 |

Next, please refer to Tables 2 to 7. Tables 2 to 7 are the test results and the characteristics of Examples 1 to 6 and Comparative Examples 1 to 6 of each group.

Additionally, in Tables 2 to 7, an algorithm for the asphalt contents of the recycled asphalt concrete materials of Comparative Examples 1 to 6 is as shown in Formula (1). Formula (1): (a weight of the extracted asphalt (kg)/a weight of the recycled asphalt concrete material (kg))*100%, and an unit is wt %. An algorithm for the asphalt contents of the asphalt concrete regenerated materials of Examples 1 to 6 is as shown in Formula (2). Formula (2): (a weight of the extracted asphalt (kg)/a weight of the asphalt concrete regenerated material (kg))*100%, and an unit is wt %. An algorithm of a viscosity reduction rate (%) is as shown in Formula (3). Formula (3): ((a viscosity of Example−a viscosity of Comparative Example)/the viscosity of Comparative Example)*100%.

TABLE 2

| | Dosage of | | | | |
|---|---|---|---|---|---|
| | viscosity | | | | |
| | reducer | Test items | | | |
| | for asphalt | Weight | | | Viscosity |
| | recycled | of | Asphalt | | reduction |
| | material | asphalt | content | Viscosity | rate |
| Groups | (kg) | (kg) | (%) | (P) | (%) |
| Comparative | 0 | 42.2 | 4.22 | 675,000 | — |
| Example 1 | | | | | |
| Example 1 | 2 | 41.7 | 4.17 | 601,000 | 11 |

Note:
P: viscosity unit,
unit: g · s⁻¹ · cm⁻¹

The surface active dispersant of the viscosity reducer for asphalt recycled material of Example 1 is, for example, lignosulfonate, the penetrant is, for example, polyol polyoxyethylene ether, and the plasticizer is, for example, sodium carboxymethyl starch.

TABLE 3

| | Dosage of | | | | |
|---|---|---|---|---|---|
| | viscosity | | | | |
| | reducer | Test items | | | |
| | for asphalt | Weight | | | Viscosity |
| | recycled | of | Asphalt | | reduction |
| | material | asphalt | content | Viscosity | rate |
| Groups | (kg) | (kg) | (%) | (P) | (%) |
| Comparative | 0 | 41.3 | 4.13 | 692,000 | — |
| Example 2 | | | | | |
| Example 2 | 2 | 41.1 | 4.11 | 551,000 | 20.4 |

The surface active dispersant of the viscosity reducer for asphalt recycled material of Example 2 is, for example, aryl sulfonate-formaldehyde condensate, the penetrant is, for example, polyol polyoxyethylene ethers, and the plasticizer is, for example, sodium carboxymethyl starch.

TABLE 4

| | Dosage of | | | | |
|---|---|---|---|---|---|
| | viscosity | | | | |
| | reducer | Test items | | | |
| | for asphalt | Weight | | | Viscosity |
| | recycled | of | Asphalt | | reduction |
| | material | asphalt | content | Viscosity | rate |
| Groups | (kg) | (kg) | (%) | (P) | (%) |
| Comparative | 0 | 41.3 | 4.13 | 692,000 | — |
| Example 3 | | | | | |
| Example 3 | 2 | 40.6 | 4.06 | 517,000 | 25.3 |

The surface active dispersant of the viscosity reducer for asphalt recycled material of Example 3 is, for example, aryl sulfonate-formaldehyde condensate, the penetrant is, for example, alkyl polyoxyethylene ether alcohol phosphate, the plasticizer is, for example, carboxymethyl cellulose, and the emulsifier is, for example, carboxylates.

TABLE 5

| | Dosage of | | | | |
|---|---|---|---|---|---|
| | viscosity | | | | |
| | reducer | Test items | | | |
| | for asphalt | Weight | | | Viscosity |
| | recycled | of | Asphalt | | reduction |
| | material | asphalt | content | Viscosity | rate |
| Groups | (kg) | (kg) | (%) | (P) | (%) |
| Comparative | 0 | 43.2 | 4.32 | 623,000 | — |
| Example 4 | | | | | |
| Example 4 | 2 | 42.5 | 4.25 | 507,000 | 18.6 |

The surface active dispersant of the viscosity reducer for asphalt recycled material of Example 4 is, for example, aliphatic hydroxysulfonate-formaldehyde condensate, the penetrant is, for example, polyol polyoxyethylene ether, and the plasticizer is, for example, triethyl citrate.

TABLE 6

| | Dosage of | | | | |
|---|---|---|---|---|---|
| | viscosity | | | | |
| | reducer | Test items | | | |
| | for asphalt | Weight | | | Viscosity |
| | recycled | of | Asphalt | | reduction |
| | material | asphalt | content | Viscosity | rate |
| Groups | (kg) | (kg) | (%) | (P) | (%) |
| Comparative | 0 | 45.3 | 4.53 | 583,000 | — |
| Example 5 | | | | | |
| Example 5 | 2 | 44.7 | 4.47 | 466,000 | 20 |

The surface active dispersant of the viscosity reducer for asphalt recycled material of Example 5 is, for example, polycarboxylic acid compound, the penetrant is, for example, alkyl polyoxyethylene ether, and the plasticizer is, for example, carboxymethylcellulose.

TABLE 7

| | Dosage of | | | | |
|---|---|---|---|---|---|
| | viscosity | | | | |
| | reducer | Test items | | | |
| | for asphalt | Weight | | | Viscosity |
| | recycled | of | Asphalt | | reduction |
| | material | asphalt | content | Viscosity | rate |
| Groups | (kg) | (kg) | (%) | (P) | (%) |
| Comparative | 0 | 45.3 | 4.53 | 583,000 | — |
| Example 6 | | | | | |
| Example 6 | 2 | 44.9 | 4.49 | 391,000 | 33 |

The surface active dispersant of the viscosity reducer for asphalt recycled material of Example 6 is, for example, polycarboxylic acid compound, the penetrant is, for example, alkyl polyoxyethylene ether, and the plasticizer is, for example, carboxymethylcellulose.

Based on Tables 2 to 7, compared Comparative Examples 1 to 6 with the asphalt concrete regenerated materials of Examples 1 to 6, the viscosity of the asphalt in the recycled asphalt concrete materials may be effectively reduced. Moreover, the viscosity reduction rate of the asphalt in the recycled asphalt concrete materials of Examples 1 to 6 is in a range from 11% to 33%. In Examples 1 to 6, the viscosity reduction rate of Example 6 is the best. Additionally, compared the asphalt contents of the various Comparative Examples with the asphalt contents of the various Examples, adding the viscosity reducer for asphalt recycled materials of Examples 1 to 6 may not increase the asphalt content in the asphalt concrete regenerated material.

The preparing processes, processing processes and characteristics of the Comparative Examples 7-1, 7-2, 8-1 and 8-2 and Examples 7 and 8 are described as following sections.

Comparative Examples 7-1 and 8-1 are related to the processing process and the characteristics of the recycled asphalt concrete materials. The processing process of the Comparative Examples 7-1 are the same as the processing process of the Comparative Examples 1 to 6, and the algorithm for the asphalt contents of the recycled asphalt concrete materials of Comparative Examples 7-1 and 8-1 is also the same, which are not repeated here.

Comparative Examples 7-2 and 8-2 are related to the processing process and the Comparative Examples. The processing process of the recycled asphalt concrete materials of Comparative Examples 7-2 and 8-2 is as follow. A total weight of 1000 kg of recycled asphalt concrete material was taken, and a weight of aged asphalt in the recycled asphalt concrete material of Comparative Example was the same as a weight of aged asphalt in the recycled asphalt concrete material of the corresponding Example. A total weight of 8.5 kg of new asphalt was added, and a weight ratio of the recycled asphalt concrete material to the new asphalt is 1000:8.5. Then, the recycled asphalt concrete material and the new asphalt were mixed at from 145° C. to 180° C. to form asphalt concrete regenerated materials of Comparative Examples 7-2 and 8-2. Further, asphalt was extracted from the asphalt concrete regenerated materials of the Comparative Examples 7-2 and 8-2. Then, a test for viscosity of the asphalt was performed through the method of test for viscosity (based on CNS 14186). Moreover, the algorithms for the asphalt content and viscosity reduction rate in the recycled asphalt concrete materials of Comparative Examples 7-2 and 8-2 are as follows, Formulas (2) and (3) respectively, which are not repeated here.

Examples 7 and 8 are related to the preparation formulation of the viscosity reducer for asphalt recycled material, and a processing process and characteristics of the recycled asphalt concrete material. The processing process of the recycled asphalt concrete materials of the Examples 7 and 8 are as follow. A total weight of 1000 kg of the recycled asphalt concrete material was taken, and the recycled asphalt concrete material contained the same weight of the aged asphalt of the corresponding Comparative Example. A total weight of 2 kg of each of the different formulations of the viscosity reducers for asphalt recycled material and a total weight of 8.5 kg of new asphalt were mixed, and a weight ratio of the recycled asphalt concrete material, the viscosity reducer for asphalt recycled material and the new asphalt was 1000:2:8.5. The recycled asphalt concrete material, the viscosity reducer for asphalt recycled material and the new asphalt were mixed at from 145° C. to 180° C. to form the asphalt concrete regenerated materials of Examples 7 and 8.

Next, the solvent, toluene, was used to extract asphalt from the recycled asphalt concrete materials of Examples 7 and 8, and a test for viscosity of the asphalt was performed through the method of test for viscosity (based on CNS 14186). Moreover, the algorithms for the asphalt content and the viscosity reduction rate in the recycled asphalt concrete materials of Examples 7 and 8 are as follows, Formulas (2) and (3) respectively, which are not repeated here.

Further, please refer to Table 8. Table 8 is a summary table of the formulations of the viscosity reducers for asphalt recycled material of Examples 7 and 8, wherein a total weight of the viscosity reducer for asphalt recycled material is calculated as 100 wt %.

TABLE 8

| | Compositions (wt %) | | | | |
|---|---|---|---|---|---|
| | Surface | | | | |
| | active | | | | |
| Examples | dispersant | Penetrant | Plasticizer | Emulsifier | Diluent |
| Example 7 | 18 | 30 | 1 | 0 | 51 |
| Example 8 | 25 | 25 | 1 | 0 | 49 |

Next, please refer to Table 9 and Table 10. Table 9 and Table 10 are test results and characteristics of Examples 7 to 8 and Comparative Examples 7-1 to 8-2 of each group.

TABLE 9

| | | Dosage of | Test items | | | |
|---|---|---|---|---|---|---|
| | | viscosity reducer | Weight | | | Viscosity |
| | Dosage of new | for asphalt | of | Asphalt | | reduction |
| | asphalt | recycled material | asphalt | content | Viscosity | rate |
| Groups | (kg) | (kg) | (kg) | (%) | (P) | (%) |
| Comparative | 0 | 0 | 45.3 | 4.53 | 583,000 | — |
| Example 7-1 | | | | | | |
| Comparative | 8.5 | 0 | 53.3 | 5.33 | 396,000 | 36.7 |
| Example 7-2 | | | | | | |
| Example 7 | 8.5 | 2 | 53.6 | 5.36 | 217,000 | 62.8 |

The surface active dispersant of the viscosity reducer for recycled asphalt materials of Example 7 is, for example, polycarboxylic acid compound, the penetrating agent is, for example, alkyl polyoxyethylene ether, and the plasticizer is, for example, triethyl citrate.

TABLE 10

| | | Dosage of | Test items | | | |
|---|---|---|---|---|---|---|
| | | viscosity reducer | Weight | | | Viscosity |
| | Dosage of new | for asphalt | of | Asphalt | | reduction |
| | asphalt | recycled material | asphalt | content | Viscosity | rate |
| Groups | (kg) | (kg) | (kg) | (%) | (P) | (%) |
| Comparative | 0 | 0 | 45.3 | 4.53 | 583,000 | — |
| Example 8-1 | | | | | | |
| Comparative | 8.5 | 0 | 53.3 | 5.33 | 396,000 | 36.7 |
| Example 8-2 | | | | | | |
| Example 8 | 8.5 | 2 | 53.8 | 5.38 | 195,000 | 66.6 |

The surface active dispersant of the viscosity reducer for recycled asphalt materials of Example 8 is, for example, polycarboxylic acid compound, the penetrating agent is, for example, alkyl polyoxyethylene ether, and the plasticizer is, for example, triethyl citrate.

Based on Table 7 and Table 8, compared with the viscosity of the asphalt of the recycled asphalt concrete materials of Comparative Examples 7-1 and 8-1, the viscosity of the asphalt of Examples 7 and 8 is significantly reduced. Moreover, the viscosity reduction rate may reach more than 60%, and the viscosity reduction rate of Example 8 even reaches more than 65%.

Moreover, compared with the viscosity of the asphalt of the recycled asphalt concrete materials of Comparative Examples 7-2 and 8-2, the viscosity of the asphalt of Examples 7 and 8 is also significantly reduced. Differences in the viscosity reduction rate between Comparative Examples 7-2/8-2 and Examples 7/8 may reach more than 25%.

Additionally, compared the asphalt contents of Comparative Example 8-2 with Examples 7/8 respectively, adding the viscosity reducer for asphalt recycled material may not increase the asphalt content of the asphalt concrete regenerated material.

A preparing process, a processing process and characteristics of Comparative Examples 9-1, 9-2, 10-1, 10-2, 11-1, and 11-2 and Examples 9, 10 and 11 are described in the following sections.

Comparative Examples 9-1, 10-1 and 11-1 are related to the processing process and the characteristics of the recycled asphalt concrete materials. The processing process of the recycled asphalt concrete materials of the Comparative Examples 9-1, 10-1 and 11-1 are the same as the processing process of the recycled asphalt concrete materials of the Comparative Examples 1 to 6, and the algorithms of asphalt content is also the same, which are not repeated here.

Comparative Examples 9-2, 10-2 and 11-2 are related to the processing process and the characteristics of the recycled asphalt concrete materials. The processing process of the recycled asphalt concrete materials of Comparative Examples 9-2 and 10-2 is as follow. A total weight of 500 kg of the recycled asphalt concrete material (containing the same weight of the aged asphalt as the corresponding Comparative Example) and a total weight of 500 kg of new concrete material were mixed. Next, total weight of 30.5 kg of new asphalt was added and mixed at from 145° C. to 180° C. to form the asphalt concrete regenerated materials of the Comparative Examples 9-2 and 10-2. Moreover, a weight ratio of the recycled asphalt concrete material, the new concrete material and the new asphalt was 500:500:30.5. The algorithms of the asphalt contents and the viscosity reduction rate of the recycled asphalt concrete materials of Examples 9, 10, 11 and Comparative Examples 9-2, 10-2 and 11-2 is the same as Formula (2) and Formula (3), respectively, which are not repeated here.

The processing process of the recycled asphalt concrete material of the Comparative Example 11-2 is as follow. A total weight of 450 kg of the recycled asphalt concrete material (containing the same weight of the aged asphalt as the corresponding Comparative Example) and a total weight of 550 kg of new concrete material were mixed. Subsequently, a total weight of 32.8 kg of new asphalt was added and mixed for 30 seconds at from 145° C. to 180° C. to form an asphalt concrete regenerated material of Comparative Example 11-2. Moreover, a weight ratio of the recycled asphalt concrete material, the new concrete material and the new asphalt was 450:550:32.8.

The solvent, toluene, was used to extract asphalt from the asphalt concrete regenerated materials of the Comparative Examples 9-2, 10-2 and 11-2. Then, a test for viscosity of the asphalt was performed through the method of test for viscosity (based on CNS 14186).

Examples 9, 10 and 11 are related to the preparation formulation of the viscosity reducer for asphalt recycled material, and a processing process and characteristics of the recycled asphalt concrete material. The processing process of the recycled asphalt concrete material of the Examples 9 and 10 is as follow. A total weight of 500 kg of the recycled asphalt concrete material (containing the same weight of the aged asphalt as the corresponding Comparative Example) and a total weight of 500 kg of new concrete material were mixed. Subsequently, a total weight of 2 kg of the viscosity reducer for asphalt recycled material and a total weight of 30.5 kg of new asphalt were mixed at from 145° C. to 180° C. to form the asphalt concrete regenerated material of Examples 9 and 10. Moreover, a weight ratio of the recycled asphalt concrete material, the new concrete material, the viscosity reducer for asphalt recycled material and the new asphalt was 500:500:2:30.5.

The processing processes of the viscosity reducer for asphalt recycled material of Example 11 are as follows. A total weight of 450 kg of recycled asphalt concrete material (containing the same weight of the aged asphalt as the corresponding Comparative Example) and a total weight of 500 kg of new concrete material were mixed. Then, a total weight of 3 kg of the viscosity reducer for asphalt recycled material and a total weight of 32.8 kg of new asphalt were added and mixed at from 145° C. to 180° C. to form the asphalt concrete regenerated material of Example 11. Moreover, a weight ratio of the recycled asphalt concrete material, the new concrete material, the viscosity reducer for asphalt recycled material, and the new asphalt was 450:550:3:32.8.

Next, the solvent, toluene, was used to extract asphalt from the recycled asphalt concrete material of Examples 9, 10 and 11, and a test for viscosity of the asphalt was performed through the method of test for viscosity (based on CNS 14186). Moreover, the algorithms for the asphalt content and the viscosity reduction rate in the recycled asphalt concrete materials of Examples 9, 10 and 11 are as follows, Formulas (2) and (3) respectively, which are not repeated here.

The formulations of the viscosity reducer for recycled asphalt materials of Examples 9, 10 and 11 are shown in Table 11.

TABLE 11

| | Compositions (wt %) | | | | |
|---|---|---|---|---|---|
| | Surface | | | | |
| | active | | | | |
| Examples | dispersant | Penetrant | Plasticizer | Emulsifier | Diluent |
| Example 9 | 25 | 25 | 1 | 0 | 49 |
| Example 10 | 35 | 20 | 5 | 1 | 39 |
| Example 11 | 25 | 20 | 1 | 0 | 54 |

Further, please refer to Table 12 to Table 14. Table 12 to Table 14 are test results and characteristics of Examples 9 to 11 and Comparative Examples 9-1 to 11-2 of each group.

TABLE 12

| | | Dosage of | Test items | | | |
|---|---|---|---|---|---|---|
| | | viscosity reducer | Weight | Content | | Viscosity |
| | Dosage of new | for asphalt | of | of | | reduction |
| | asphalt | recycled material | asphalt | asphalt | Viscosity | rate |
| Groups | (kg) | (kg) | (kg) | (%) | (P) | (%) |
| Comparative | 0 | 0 | 42.2 | 4.22 | 583,000 | — |
| Example 9-1 | | | | | | |
| Comparative | 30.5 | 0 | 49.8 | 4.98 | 157,000 | 73.1 |
| Example 9-2 | | | | | | |
| Example 9 | 30.5 | 2 | 49.4 | 4.94 | 76,000 | 87 |

In the viscosity reducer for recycled asphalt material of Example 9, the surface active dispersant is, for example, polycarboxylic acid compound, the penetrant is, for example, polyol polyoxyethylene ether, and the plasticizer is, for example, triethyl citrate.

TABLE 13

| | | Dosage of | Test items | | | |
|---|---|---|---|---|---|---|
| | | viscosity reducer | Weight | | | Viscosity |
| | Dosage of new | for asphalt | of | Asphalt | | reduction |
| | asphalt | recycled material | asphalt | content | Viscosity | rate |
| Groups | (kg) | (kg) | (kg) | (%) | (P) | (%) |
| Comparative | 0 | 0 | 42.2 | 4.22 | 583,000 | — |
| Example | | | | | | |
| 10-1 | | | | | | |
| Comparative | 30.5 | 0 | 49.8 | 4.98 | 157,000 | 73.1 |
| Example | | | | | | |
| 10-2 | | | | | | |
| Example 10 | 30.5 | 2 | 50.7 | 5.07 | 68,000 | 88.3 |

In the viscosity reducer for recycled asphalt material of Example 10, the surface active dispersant is, for example, a polycarboxylic acid compound, the penetrant is, for example, alkyl polyoxyethylene ether alcohol phosphate, the plasticizer is, for example, triethyl citrate, and the emulsifier is, for example, carboxylates.

TABLE 14

| | | Dosage of | Test items | | | |
|---|---|---|---|---|---|---|
| | | viscosity reducer | Weight | | | Viscosity |
| | Dosage of new | for asphalt | of | Asphalt | | reduction |
| | asphalt | recycled material | asphalt | content | Viscosity | rate |
| Groups | (kg) | (kg) | (kg) | (%) | (P) | (%) |
| Comparative | 0 | 0 | 42.7 | 4.27 | 82,500 | — |
| Example | | | | | | |
| 11-1 | | | | | | |
| Comparative | 32.8 | 0 | 54.2 | 5.42 | 7,400 | 91 |
| Example | | | | | | |
| 11-2 | | | | | | |
| Example 11 | 32.8 | 3 | 53.8 | 5.38 | 5,600 | 93.2 |

In the viscosity reducer for recycled asphalt material of Example 11, the surface active dispersant is, for example, a polycarboxylic acid compound, the penetrating agent is, for example, polyol polyoxyethylene ether, and the plasticizer is, for example, sodium carboxymethyl starch.

Based on Table 12, Table 13 and Table 14, compared with the viscosity of the asphalt of the asphalt concrete regenerated materials of the Comparative Examples 9-1, 10-1 and 11-1, the viscosity of the asphalt of Examples 9, 10 and 11 is significantly reduced. The viscosity reduction rate of Examples 9, 10 and 11 may reach more than 85%. In addition, based on Examples 9 and 10, adding 2 kg of the viscosity reducer for recycled asphalt material may effectively reduce the viscosity of the asphalt of the recycled asphalt concrete material containing 50% of the recycled asphalt concrete material.

Furthermore, compared with the viscosity of the asphalt of the recycled asphalt concrete materials of Comparative Examples 9-2 and 10-2, the viscosity of the asphalt of Examples 9 and 10 also has significant differences.

Additionally, compared with Comparative Examples 9-2, 10-2 and 11-2, adding the he viscosity reducer for recycled asphalt material may not increase the asphalt content of the asphalt concrete regenerated materials of Examples 9, 10 and 11.

As stated as above, the viscosity reducer for asphalt recycled material of this disclosure has advantages of low preparation cost and simple preparation method. Moreover, the viscosity reducer for asphalt recycled material of this disclosure may be used for the regeneration of the recycled asphalt concrete materials. Through the surface active dispersant and the penetrant of the viscosity reducer for asphalt recycled material, the aged asphalt may be effectively dispersed, so that the viscosity of the aged asphalt may be reduced. Additionally, the integration of the aged asphalt and the new asphalt may be promoted effectively. The performance of the asphalt concrete regenerated material may be optimized, which may provide better workability. Therefore, the recycled asphalt concrete material may be reused well, resulting in good resource utilization and economic benefit.

Furthermore, it is not need to add the petrochemical products such as low-viscosity light oil or heavy oil, through the viscosity reducer for asphalt recycled material. Thus, the burning problem may not occur by volatilization during high-temperature production processes. In addition, since the viscosity reducer for asphalt recycled material may not contain oily components, such as low-viscosity light oil or heavy oil, the asphalt content of the asphalt concrete regenerated material may not be affected. Therefore, the problems, such as rutting and deformation of asphalt concrete pavement due to excessive asphalt content, that makes the road surface soft may not occur.

Although this disclosure has been disclosed in the above embodiments, the embodiments are not intended to limit this disclosure. Those skilled in the art should appreciate that they may readily use the present disclosure as a basis for designing or modifying other processes and structures of the embodiments introduced herein. Therefore, the protection scope of this disclosure shall be determined by the appended claim as below.

What is claimed is:

1. A viscosity reducer for asphalt recycled material, comprising:
10% to 40% by weight of a surface active dispersant;
20% to 40% by weight of a penetrant;
1% to 5% by weight of a plasticizer;
0% to 5% by weight of a emulsifier; and
a remaining proportion of a diluent.

2. The viscosity reducer for asphalt recycled material of claim 1, wherein the surface active dispersant comprises lignosulfonate, humic acid sulfonate, polyoxyindene resin sulfonate, aryl sulfonate-formaldehyde condensate, aliphatic condensate, phenyl polyoxyethylene hydroxysulfonate-formaldehyde ether-formaldehyde condensate, polycarboxylic acid compound, or a combination thereof.

3. The viscosity reducer for asphalt recycled material of claim 1, wherein the penetrant comprises alkyl polyoxyethylene ether, alkylphenol polyoxyethylene ether, aromatic hydrocarbon polyoxyethylene ether, styrene aromatic hydrocarbon polyoxyethylene ether, polyol polyoxyethylene ether, alkylamine polyoxyethylene ether, alkyl polyoxyethylene polyoxypropylene ether, alkylphenol polyoxyethylene polyoxypropylene ether, aromatic hydrocarbon polyoxyethylene polyoxypropylene ether, styrene aromatic hydrocarbon polyoxyethylene, polyoxypropylene ether, polyol polyoxyethylene polyoxypropylene ether, alkylamine polyoxyethylene polyoxypropylene ether, alkyl phosphate, alkyl polyoxyethylene ether alcohol phosphate, alkylphenol polyoxyethylene ether alcohol phosphate, ethoxylated fatty alcohol, fatty alcohol polyoxyethylene ether, fatty alcohol polyetheramide, polyurethane, polyurethane-acrylic copolymer, or a combination thereof.

4. The viscosity reducer for asphalt recycled material of claim 1, wherein the plasticizer is sodium carboxymethyl starch, carboxymethyl cellulose, hydroxyethyl cellulose, hydroxypropyl cellulose, triethyl citrate, acetyltriethyl acetate, acetyltributyl citrate, tributyl acetate, acetyltrihexyl acetate, acetylated monoglyceride, dibutyl maleate, tributyl phosphate, phthalates, terephthalates, or a combination thereof.

5. The viscosity reducer for asphalt recycled material of claim 1, wherein the emulsifier is a carboxylate emulsifier, a sulfonate emulsifier, an ammonium salt emulsifier, an alkylphenol polyoxyethylene ether emulsifier, benzylphenol polyoxyethylene ether, phenethylphenol polyoxyethylene ether, fatty alcohol polyoxyethylene ether, or a combination thereof.

6. A method of preparing a viscosity reducer for asphalt recycled material, comprising:
weighing 10 wt % to 40 wt % of a surface active dispersant, 20 wt % to 40 wt % of a penetrant, 1 wt % to 5 wt % of a plasticizer, 0 wt % to 5 wt % of a an emulsifier, and a remaining proportion of a diluent, respectively;
putting the surface active dispersant and the penetrant into a stirring tank;
heating up a temperature of the stirring tank to from 40° C. to 70° C., and stirring at a rotation speed of 300 rpm to 500 rpm for 10 minutes to 15 minutes;
maintaining the temperature, and adding the diluent and stirring at the rotation speed for 10 minutes to 15 minutes;
adding the plasticizer and stirring at the rotation speed for 15 minutes to 30 minutes to form a mixture; and
cooling the mixture to a room temperature.

7. The method of claim 6, wherein the emulsifier and the plasticizer are added at the same time.

8. A method for applying a viscosity reducer for asphalt recycled material to a recycled asphalt concrete material, comprising:
providing the recycled asphalt concrete material, wherein the recycled asphalt concrete material comprises an aged asphalt;
adding a new asphalt; and
mixing the recycled asphalt concrete material and the new asphalt evenly at a temperature of from 145° C. to 180° C., adding the viscosity reducer for asphalt recycled material, and mix continuously and evenly at the temperature to obtain an asphalt concrete regenerated material;
wherein the viscosity reducer for asphalt recycled material comprises a surface active dispersant, and the surface active dispersant comprises a plurality of hydrophilic ends and a plurality of lipophilic ends, and
wherein after the plurality of lipophilic ends are adsorbed on a surface of the aged asphalt, the agglomerated aged asphalt is dispersed through a charge repulsion of a same charge among each of the plurality of hydrophilic ends, so as to reduce an asphalt viscosity of the recycled asphalt concrete material.

9. The method of claim 8, wherein the viscosity reducer for asphalt recycled material comprises a penetrant, and the penetrant allows the surface active dispersant to penetrate into the agglomerated aged asphalt.

10. A method for applying a viscosity reducer for asphalt recycled material to a recycled asphalt concrete material, comprising:
mixing the recycled asphalt concrete material and a new concrete material at a temperature of from 145° C. to 180° C. evenly to form a first recycled material mixture, wherein the recycled asphalt concrete comprises an aged asphalt;
adding a new asphalt into the first recycled material mixture, and mixing the first recycled material mixture and the new asphalt at the temperature to form a second recycled material mixture; and
adding the viscosity reducer for asphalt recycled material into the second recycled material mixture, and mixing continuously the second recycled material mixture evenly at the temperature to obtain an asphalt concrete regenerated material,
wherein the viscosity reducer for asphalt recycled material comprises a surface active dispersant, and the surface active dispersant comprises a plurality of hydrophilic ends and a plurality of lipophilic ends, and
wherein after the plurality of lipophilic ends are adsorbed on a surface of the aged asphalt, the agglomerated aged asphalt is dispersed through a charge repulsion of a same charge among each of the plurality of hydrophilic ends, so as to reduce an asphalt viscosity of the recycled asphalt concrete material.
